(19) United States
(12) Patent Application Publication
(10) Pub. No.: US 2014/0169832 A1
(43) Pub. Date: Jun. 19, 2014

(54) CORONA DISCHARGER, AND IMAGE FORMING APPARATUS

(71) Applicant: Fuji Xerox Co., Ltd., Tokyo (JP)

(72) Inventors: Yuki NAGAMORI, Kanagawa (JP); Koji OTSUKA, Kanagawa (JP); Masafumi KUDO, Kanagawa (JP); Kazuki INAMI, Kanagawa (JP); Yasunori MOMOMURA, Kanagawa (JP)

(73) Assignee: FUJI XEROX CO., LTD., Tokyo (JP)

(21) Appl. No.: 13/902,260

(22) Filed: May 24, 2013

(30) Foreign Application Priority Data
Dec. 13, 2012 (JP) 2012-272067

(51) Int. Cl. G03G 15/02; H01H 47/32

(52) U.S. Cl. CPC G03G 15/0291
USPC 399/172; 361/229

(57) ABSTRACT

A corona discharger includes a discharge wire, and a surrounding member, that is provided with an opening portion which is an entrance of an air flow, that faces a surface of a member to be charged that rotates around a rotational axis of the member to be charged, that is arranged with a gap from the surface to be charged, and that surrounds the discharge wire in the direction of the rotational axis, wherein the opening portion is provided at a part of the surrounding member located on the upstream side of the discharge wire in a rotational direction of the member to be charged with the discharge wire.

### CROSS-REFERENCE TO RELATED APPLICATIONS

This application is based on and claims priority under 35 USC 119 from Japanese Patent Application No. 2012-272067 filed Dec. 13, 2012.

### BACKGROUND

(i) Technical Field

The present invention relates to a corona discharger, and an image forming apparatus.

(ii) Related Art

In image forming apparatuses that adopt image recording systems, such as an electrophotographic system, for example, a corona discharger that performs corona discharge may be used in order to charge or charge-remove a member to be charged, such as a drum-shaped or belt-shaped photoconductor, an intermediate transfer member, or sheet transporting member, which rotates and circularly moves.

In such a corona discharger, discharge products, such as ozone, maybe generated due to corona discharge, and uneven discharge or degradation of charge (charge removal) performance may be caused due to the presence of the discharge products. For this reason, even in the related art, as illustrated below, a corona discharger is known that is configured to have a charging device or the like in which a measure for emitting undesired substances, such as the discharge products, from the inside of a surrounding member (a shielding case or a frame member) is taken.

### SUMMARY

According to an aspect of the invention, there is provided a corona discharger including: a discharge wire; and a surrounding member, that is provided with an opening portion which is an entrance of an air flow, that faces a surface of a member to be charged that rotates around a rotational axis of the member to be charged, that is arranged with a gap from the surface to be charged, and that surrounds the discharge wire in the direction of the rotational axis, wherein the opening portion is provided at a part of the surrounding member located on the upstream side of the discharge wire in a rotational direction of the member to be charged with the discharge wire.

### BRIEF DESCRIPTION OF THE DRAWINGS

Exemplary embodiments of the present invention will be described in detail based on the following figures, wherein:

FIG. 1 is an explanatory view illustrating the outline of an image forming apparatus including a charging device related to Exemplary Embodiment 1;

FIG. 2 is a schematic perspective view illustrating the charging device including a corona discharger in FIG. 1;

FIG. 3 is an explanatory view illustrating a state when seen from the side surface side of the charging device of FIG. 2;

FIG. 4 is a schematic cross-sectional view along line Q-Q of the charging device of FIG. 2;

FIG. 5 is a schematic cross-sectional view illustrating the state of an air flow generated in the charging device of FIG. 2;

FIGS. 6A and 6B illustrate another configuration of the charging device related to Exemplary Embodiment 1, FIG. 6A being a schematic cross-sectional view illustrating the configuration of the charging device, and FIG. 6B being a schematic cross-sectional view illustrating the state of an air flow generated in the charging device;

FIG. 7 is a schematic cross-sectional view illustrating the configuration or the like of the charging device of Comparative Example 1;

FIG. 8 is an explanatory view illustrating the outline of an image forming apparatus including a charging device related to Exemplary Embodiment 2;

FIG. 9 is a partial cross-sectional explanatory view illustrating an image forming device or the like in the image forming apparatus of FIG. 1;

FIG. 10 is a schematic perspective view illustrating the charging device including a corona discharger in FIG. 9;

FIG. 11 is a schematic cross-sectional view along line Q-Q of the charging device of FIG. 10;

FIG. 12 is a schematic cross-sectional view illustrating the charging device of FIG. 10 and a blowing device (blower duct) that is provided together with the charging device;

FIG. 13 is a schematic perspective view illustrating the blowing device of FIG. 12;

FIG. 14 is a schematic cross-sectional view illustrating the state of the blowing operation of the blowing device of FIG. 12;

FIG. 15 is a schematic cross-sectional view illustrating the state of an air flow generated in the charging device of FIG. 10;

FIG. 16 is an explanatory view illustrating the measurement positions of ozone in a performance test;

FIG. 17 is a graph chart illustrating the results of the performance test regarding the charging device related to Exemplary Embodiment 2;

FIG. 18 is a schematic cross-sectional view illustrating the configuration or the like of the charging device of Comparative Example 2;

FIG. 19 is a graph chart illustrating the results of the performance test regarding the charging device of Comparative Example 2;

FIGS. 20A and 20B illustrate Modified Example 1 of the charging device related to Exemplary Embodiment 2, FIG. 20A being a schematic cross-sectional view illustrating the configuration of the charging device, and FIG. 20B being a schematic cross-sectional view illustrating the state of an air flow generated in the charging device; and

FIGS. 21A and 21B illustrate Modified Example 2 of the charging device related to Exemplary Embodiment 2, FIG. 21A being a schematic cross-sectional view illustrating the configuration of the charging device, and FIG. 21B being a schematic cross-sectional view illustrating the state of an air flow generated in the charging device.

### DETAILED DESCRIPTION

Hereinafter, the modes (hereinafter referred to as “exemplary embodiments”) for carrying out the invention will be described in detail with reference to the accompanying drawings.

### Exemplary Embodiment 1

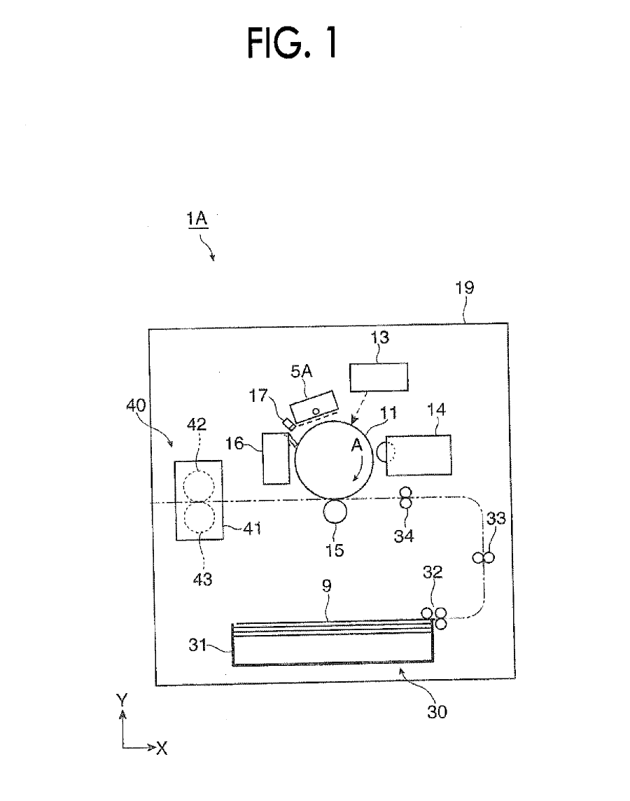

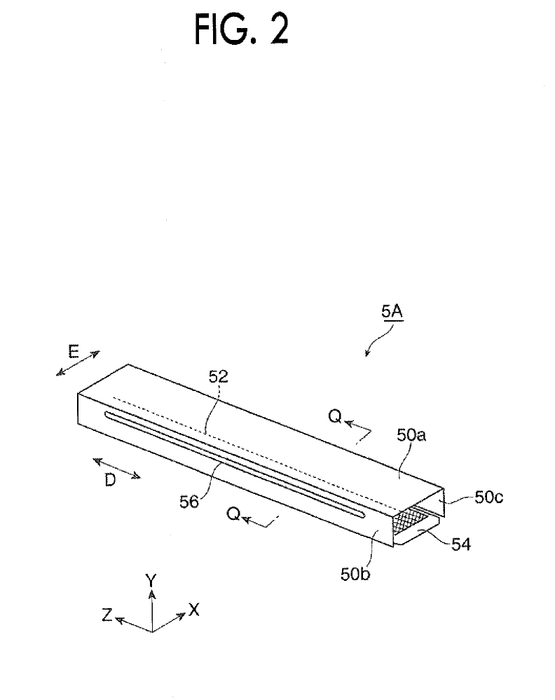

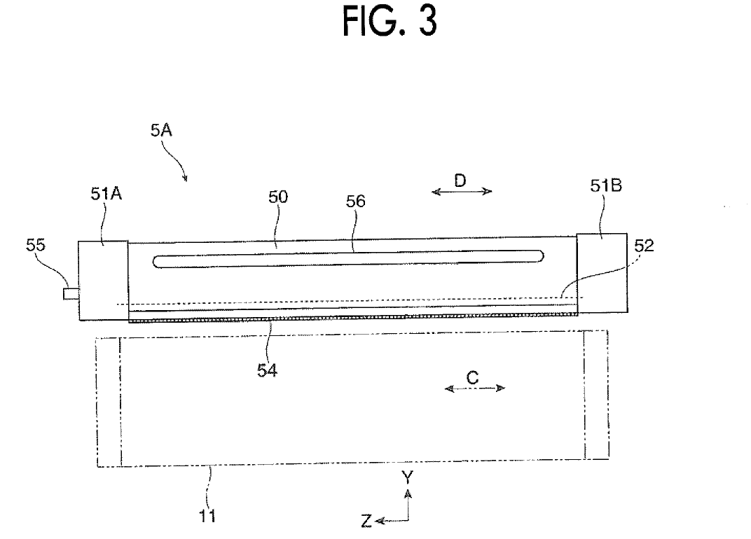

FIGS. 1 to 3 illustrate an image forming apparatus using a charging device as an example of a corona discharger related to Exemplary Embodiment 1. FIG. 1 illustrates the outline of the image forming apparatus, FIG. 2 illustrates an image forming device in the image forming apparatus, and FIG. 3 illustrates a portion of the charging device.

Configuration (Including Charging Device) of Image Forming Apparatus

An image forming apparatus 1A related to Exemplary Embodiment 1 is constituted of a printer for a monochrome image (for example, black and white). In the image forming apparatus 1, as illustrated in FIG. 1, an image forming unit 10 that forms a toner image constituted of a toner (powder subjected to coloring or the like) that constitutes a developer to transfer the toner image to a sheet 9 as an example of a recording material, a sheet feeder 30 that accommodates and transports sheets 9 to be supplied to the image forming unit 10, and a fixing device 40 that fixes the toner image formed by the image forming unit 10 on a sheet 9 are installed in an internal space of a housing 19 constituted by a support frame, an outer cover, or the like. A one-dot chain line in FIG. 1 illustrates a main transporting path which a sheet 9 is transported along and passes through.

The image forming unit 10 is configured, for example, utilizing a well-known electrophotographic system. The image forming unit 10 is mainly constituted by a photoconductor drum 11 that is rotationally driven in the direction (the clockwise direction in the drawing) indicated by arrow A, a charging device 5A that charges a peripheral surface (a surface to be charged) with a required potential, which becomes an image forming region of the photoconductor drum 11, an exposure device 13 that irradiates the surface of the photoconductor drum 11 with light (dotted line with an arrow) after the charging based on image information (signal) input from the outside to forms an electrostatic latent image with a potential difference, a developing device 14 that develops the electrostatic latent image as the toner image with the toner to be supplied by a developing roll 14a or the like, a transfer device 15 that transfers the toner image to a sheet 9, a cleaning device 16 that removes and cleans the toner or the like, which remains on the surface of the photoconductor drum 11 after the transfer, by a cleaning plate 16a or the like, and a charge remover 17 that removes the charge of the surface of the photoconductor drum 11 after the transfer and cleaning.

The charging device 5A, as illustrated in FIGS. 2 to 4 or the like, is constituted as a so-called scorotron type charging device including a shielding case 50 as an example of a surrounding member, two end supports 51A and 51B (not illustrated in FIG. 2 or the like), one corona discharge wire 52, and a grid electrode (electric field adjustment plate) 54.

The shielding case 50 is the surrounding member including an external shape having an oblong top plate 50a, and long side lateral plates 50b and 50c that hang downward from a long side portion extending along a longitudinal direction C of the top plate 50a, and having a discharge opening portion 53 provided at the bottom thereof, and is formed by a member exhibiting conductivity. The two end supports 51A and 51B are structures attached in a state where the end supports 51A and 51B are respectively fitted into both ends (short side portion) of the shielding case 50 in a longitudinal direction D, and are mainly formed by members exhibiting non-conductivity.

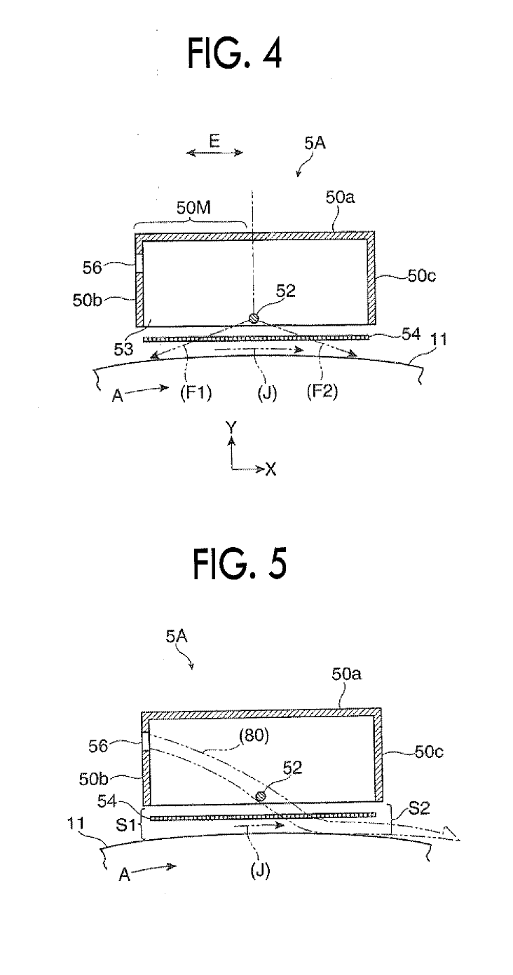

The corona discharge wire 52 is a metal wire that is made of metallic material, such as tungsten, and has a diameter of approximately 0.04 mm, and is attached so as to pass through the internal space of the shielding case 50 and be stretched substantially in the shape of a straight line between the two end supports 51A and 51B. The corona discharge wire 52 is attached in the stretched state substantially parallel to the axial direction C of the photoconductor drum 11 that is an example of a member to be charged, in a stage where the charging device 5 is installed. Additionally, the corona discharge wire 52, as illustrated in FIG. 4, is arranged substantially at the center in a lateral direction E of the shielding case 50, and is arranged near an opening edge of the discharge opening portion 53.

The grid electrode (electric field adjustment plate) 54 is a grid-like electrode plate that is attached so as to cover the discharge opening portion 53 of the shielding case 50 and be present between the corona discharge wire 52 and the peripheral surface of the photoconductor drum 11. Reference numeral 55 in FIG. 4 represents a connecting terminal for inputting a charging (discharging) voltage supplied to the corona discharge wire 52.

The charging device 5A is arranged such that the corona discharge wire 52 faces the peripheral surface (the surface to be charged) of the photoconductor drum 11 with a required gap (for example, a discharge gap), and is present at least in an image forming target region along the direction C of the rotational axis of the photoconductor drum 11. Additionally, in the charging device 5A, a charging voltage is applied to the discharge wire 52 (between the discharge wire and the photoconductor drum 11) from a power supply unit (not illustrated) if required timing, such as image forming operation timing, comes. In Exemplary Embodiment 1, for example, an alternating voltage is supplied as the charging voltage.

The sheet feeder 30 includes a sheet accommodation member 31 of a tray type, a cassette type, or the like that accommodates plural sheets 9 including a required size, required kind, or the like to be used for formation of an image, in a stacked state, and a delivery device 32 that delivers the sheets 9 accommodated in the sheet accommodation member 31 one by one toward a transporting path. The sheet accommodation member 31 is structured so as to be pulled out, for example, to the outside of the housing 19 for the supply operation or the like of a sheet 9, and plural sheet accommodation members are provided according to utilization modes. The sheet feeder 30 delivers the sheets 9 in the sheet accommodation member 31 sheet by sheet by the delivery device 32 if a timing for sheet feeding comes. The transporting path for sheets provided between the sheet feeder 30 and the image forming device 10 is constituted by plural sheet transporting roll pairs 33 and 34, transporting guide members (not illustrated), or the like.

The fixing device 40 includes, inside a housing 41 formed with an introduction port and an ejection port through which a sheet 9 passes, a roller-shaped or belt-shaped heating rotary member 42 of which the surface temperature is heated to and maintained at a required temperature by a heating unit, and a roller-shaped or belt-shaped pressurizing rotary member 43 that is rotationally driven in contact with the heating rotary member 42 at a required pressure so as to extend substantially along the direction of the rotational axis of the heating rotary member. The fixing device 40 performs fixing by allowing a sheet 9 to which a toner image is transferred to be introduced into and pass through a contact portion (fixing processing section) that is formed as the heating rotary member 42 and the pressurizing rotary member 43 come into contact with each other.

Image formation by the image forming apparatus 1A is performed as follows. Here, a basic image forming operation when an image is formed on one surface of a sheet 9 will be described as an example.

In the image forming apparatus 1A, if a start command for an image forming operation is received, in the image forming unit 10, the peripheral surface of the photoconductor drum 11 that starts to rotate is charged with predetermined polarity and potential by the charging device 5A. At this time, in the charging device 5A, corona discharge is generated in a state where a charging voltage is applied to the corona discharge wire 52 and an electric field is formed between the discharge wire 52 and the peripheral surface of the photoconductor drum 11, and thereby, the peripheral surface of the photoconductor drum 11 is charged with a required potential. In this case, the charging potential of the photoconductor drum 11 is adjusted by the grid electrode 54.

Subsequently, an electrostatic latent image, which is configured with a required potential difference as exposure is performed on the basis of image information from the exposure device 13, is formed on the peripheral surface of the charged photoconductor drum 11. Thereafter, when the electrostatic latent image formed on the photoconductor drum 11 passes through the developing device 14, the electrostatic latent image is developed with a toner that is supplied from the developing roll 14a and is charged with a required polarity, and then is visualized as a toner image.

Next, if the toner image formed on the photoconductor drum 11 is transported to a transfer position where the toner image faces the transfer device 15 by the rotation of the photoconductor drum 11, the toner image is transferred by the transfer device 15 to a sheet 9 to be supplied through the transporting path from the sheet feeder 30 according to this timing. The peripheral surface of the photoconductor drum 11 after this transfer is cleaned by the cleaning device 16, and is then charge-removed by the charge remover 17.

Subsequently, the sheet 9 to which the toner image is transferred in the image forming unit 2 is transported so as to be introduced into the fixing device 40 after being peeled off from the photoconductor drum 11, and is heated under pressurization when passing through the contact portion between the heating rotary member 42 and the pressurizing rotary member 43 in the fixing device 40, and then the toner image is melt and fixed on the sheet 9. The sheet 9 after this fixing is completed is ejected from the fixing device 40, and is transported to and accommodated in an ejected sheet accommodation section (not illustrated) or the like that is formed outside the housing 19 or the like.

From the above, a monochrome image constituted by a single-color toner is formed on one surface of one sheet 9, and the basic image forming operation is completed. When there is an instruction for the image forming operation for plural sheets, a series of operations as described above are similarly repeated by the number of sheets.

Detailed Configuration of Charging Device

Additionally, in the charging device 5A related to Exemplary Embodiment 1, as illustrated in FIGS. 2 to 4 or the like, an air introduction opening portion 56 that introduces air is provided in the long side lateral plate 50b that is an example of a part 50M of the shielding case 50 located on the upstream side in the rotational direction A of the photoconductor drum 11 with reference to the corona discharge wire 52 as a boundary.

The air introduction opening portion 56 is formed as an elongated hole along the longitudinal direction D in the upstream long side lateral plate 50b that rises in a substantially perpendicular direction (a direction normal) to the peripheral surface (cylindrical surface) of the photoconductor drum 11. The opening portion 56 is formed so as to be present in an upper region (more specifically, a part that becomes uppermost ⅓ as seen in the height direction of the lateral plate) of the long side lateral plate 50b. In addition, conditions, such as the forming position, dimension, and shape, of the air introduction opening portion 56, are set from the viewpoint that an air flow for emitting discharge products to be described below in a predetermined direction may be generated by the air taken from the opening portion 53 (this point is also the same with another air introduction opening portion to be described below).

In the charging device 5A, when charge is performed, discharge products, such as ozone resulting from charges generated by corona discharge, are generated around the corona discharge wire 52 to which a charging voltage is supplied. Additionally, the discharge products, as illustrated in FIG. 4, are influenced by air flows F1 and F2 that are generated due to a potential difference (electric field) between the corona discharge wire 52 and the peripheral surface of the photoconductor drum 11 and are directed to the peripheral surface of the photoconductor drum 11 from the discharge wire 52, and an air flow J generated between the peripheral surface of the photoconductor drum 11 and (the opening portion 53 of the shielding case 50 of) the charging device 5A by the rotation of the photoconductor drum 11,and are emitted to the outside, respectively, from gaps S1 and S2 between the shielding case 50 and the peripheral surface of the photoconductor drum 11 (FIG. 5).

Here, the air flow F1 is a flow that flows toward the upstream side in the rotational direction A of the photoconductor drum 11 from the discharge wire 52 with reference to the discharge wire 52, and the air flow F2 is a flow that flows toward the downstream side in the rotational direction A of the photoconductor drum 11 from the discharge wire 52 with reference to the discharge wire 52. The gap S1 is a gap located on the upstream side in the rotational direction A of the photoconductor drum 11, and the gap S2 is a gap located on the downstream side in the rotational direction A of the photoconductor drum 11.

In contrast, in the charging device 5A, as illustrated by two-dot chain lines in FIG. 5, the air outside the case 50 is introduced from the air introduction opening portion 56 provided in the upstream long side lateral plate 50b into the internal space of the shielding case 50 the periphery of which is substantially surrounded except for the discharge opening portion 53, and the air is an air flow 80 that flows so as to be emitted to the outside through the downstream gap S2 between the shielding case 50 and the peripheral surface of the photoconductor drum 11. Additionally, the air flow 80 flows so that a portion thereof passes through the discharge wire 52 and its periphery.

Incidentally, it is inferred that a reason why air introduced from the air introduction opening portion 56 flows so as to be emitted to the outside through the downstream gap S2 between the shielding case 50 and the peripheral surface of the photoconductor drum 11 is because air flows so as to be attracted, particularly under the influence of the air flow J generated by the rotation of the photoconductor drum 11. Additionally, it is inferred that a reason why air flow 80 flows so as to pass through the discharge wire 52 and its periphery is because air flows so as to be drawn to one side under the influence of the air flow F2 generated due to a potential difference between the corona discharge wire 52 and the peripheral surface of the photoconductor drum 11. Moreover, the air flow F1 that is generated due to a potential difference between the corona discharge wire 52 and the peripheral surface of the photoconductor drum 11 and that flows toward the upstream side in the rotational direction A of the photoconductor drum 11 from the discharge wire 52 is also generated in the charging device 5A in addition to the air flow 80, however, the wind force of the air flow F1 is relatively weaker than the wind force of the air flow 80.

As a result, as the air flow 80 is generated in the charging device 5A, discharge products generated around the discharge wire 52 may be made to ride on the air flow 80 and may be emitted relatively much from the downstream gap S2 between the shielding case 50 and the peripheral surface of the photoconductor drum 11. In addition, even in a case where the air introduction opening portion 56 is provided in a part that faces and approaches the charge remover 17 as in the charging device 5A, there is no concern that a bad influence is exerted on a charging processing by the charging device 5A, if needed, for example, by taking measures, such as providing a lid that cover the opening portion 56 from outside so as to keep the action of the charge remover 17 from being exerted on the opening portion 56, forming the opening portion 56 in the shape of a net, or providing a filter to the opening portion 56. In this case, particularly when the filter is provided together, powder dust, such as toner that floats around the charging device 5A, is also prevented from entering the shielding case 50.

Thereby, in the charging device 5A, the discharge products generated around the discharge wire 52 may be released to a release space where there is present a comparatively much empty space in a peripheral portion between the charging device 5A of the photoconductor drum 11 and the developing device 14, and for example, adhesion of the discharge products to the discharge wire 52 itself may be suppressed. In addition to these, occurrence of such a problem that the emitted discharge products adhere to the peripheral surface of the photoconductor drum 11 and charge performance is degraded may also be suppressed compared with a closed space where the peripheral portion of the photoconductor drum 11 between the charging device 5A and the cleaning device 16 is comparatively closed.

In the image forming apparatus 1A, the effects as described above are obtained by the charging device 5A. Thereby, occurrence of disadvantages, such as uneven discharge in the charging device 5A, uneven concentration resulting from degradation of charge performance in the photoconductor drum 11, and deterioration of the quality of an image represented by white stripe generation or the like, is supprressed.

### COMPARATIVE EXAMPLE 1

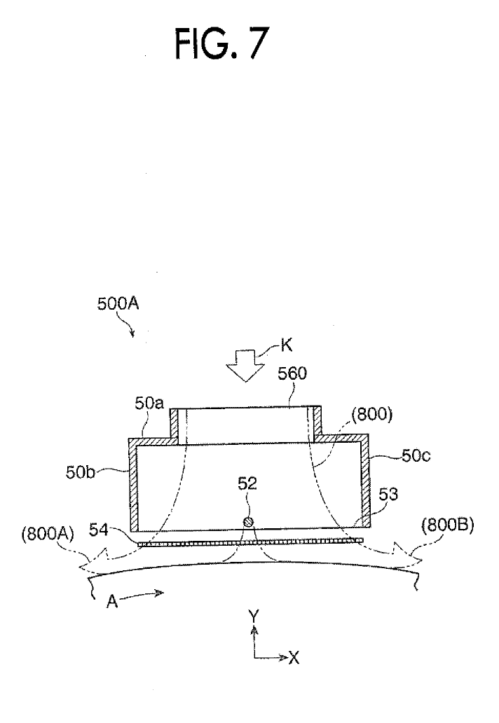

Just for reference with respect to the charging device 5A, in a charging device 500A as Comparative Example 1 illustrated in FIG. 7 emission of discharge products is performed as below.

In a case where the charging device 500A of Comparative Example 1 is compared with the charging device 5 related to Exemplary Embodiment 1, there is a difference in that the top plate 50a of the shielding case 50 is provided with an air introduction opening portion 560. The opening portion 560 is formed as an oblong long hole along the longitudinal direction of the oblong top plate 50a. Additionally, in the charging device 500A, an air K from a fan blower that is not illustrated is forcedly introduced toward the internal space of the shielding case 50 from the air introduction opening portion 560.

Also, in the charging device 500A, as illustrated by two-dot chain lines in FIG. 7, air is forcedly introduced from the air introduction opening portion 560 provided in the top plate 50a into the internal space of the shielding case 50, and the air is finally generated as an air flow 800 that is divided so as to pass through both the upstream gap S1 and the downstream gap S2, respectively, between the shielding case 50 and the peripheral surface of the photoconductor drum 11, and flows so as to be emitted to the outside. The air flow 800 is mainly divided into an air flow portion 800A that flows so as to be emitted through the upstream gap S1, and an air flow portion 800B that flows so as to be emitted through the downstream gap S2.

Incidentally, it is inferred that the divided air flow portion 800A and air flow portion 800B are divided and flows as the air forcedly introduced from the opening portion 560 naturally proceeds to sides, respectively, where naturally escaping gaps are present in the peripheral surface of the photoconductor drum 11, but the divided air flow portions flow while being also influenced by the aforementioned air flows F1 and F2 (refer to FIG. 4) that are generated due to a potential difference between the discharge wire 52 and the peripheral surface of the photoconductor drum 11, and that flow toward the upstream side and downstream side in the rotational direction A of the photoconductor drum 11, respectively, from the discharge wire 52. For this reason, the divided air flow portion 800A and air flow portion 800B are air flows that flow with almost the same air volume.

As a result, in the charging device 500A, the discharge products generated around the discharge wire 52 maybe emitted to the outside through the upstream gap S1 and the downstream 52 between the shielding case 50 and the peripheral surface of the photoconductor drum 11 by (the portions 800A and 800B of) the air flow 800. Thereby, in the charging device 500A, approximately half of the discharge products emitted through the upstream gap S1 is also present. Therefore, the problems such as the discharge products stagnating in a closed space where the peripheral portion of the photoconductor drum 11 between the charging device 5A and the cleaning devices 16 is comparatively closed, and the emitted discharge products adhering to the peripheral surface of the photoconductor drum 11 may be caused. The closed space tends to become a closed space due to the presence of the cleaning plate 16a of the cleaning device 16 or of the charge remover 17, and for this reason, the emitted discharge products are banked and tend to remain in the closed space.

Modified Example of Charging Device

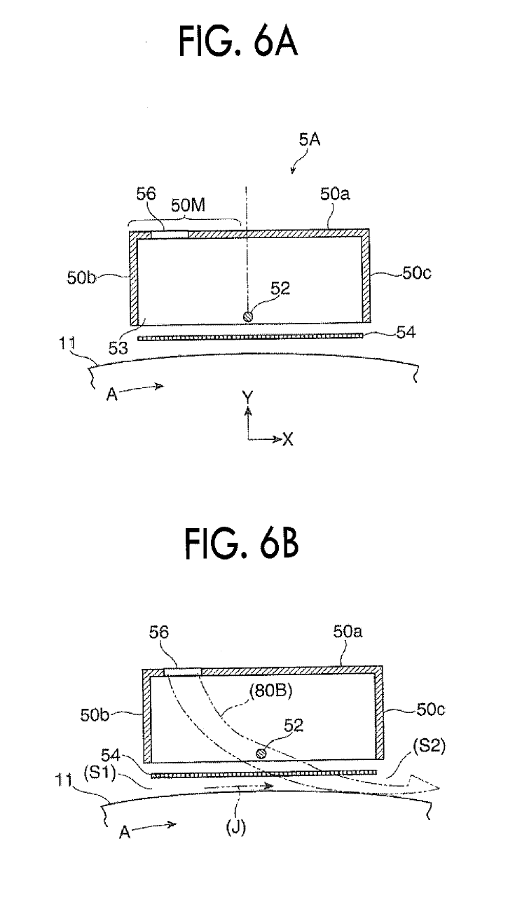

FIGS. 6A and 6B illustrate a modified example of the charging device 5A related to Exemplary Embodiment 1.

In the charging device 5A of this modified example, as illustrated in FIG. 6A, the air introduction opening portion 56 is provided in a portion of the top plate 50a that is an example of the part 50M located on the upstream side in the rotational direction A of the photoconductor drum 11 with reference to the corona discharge wire 52 of the shielding case 50 as a boundary. The air introduction opening portion 56 is formed as an elongated hole along the longitudinal direction D of the top plate 50a, substantially similarly to the opening portion 56 in Exemplary Embodiment 1. Additionally, the opening portion 56 is formed so as to be present in an upstream portion of two equally divided portions in the upstream part 50M of the top plate 50a.

Also in the charging device 5A, as illustrated by two-dot chain lines in FIG. 6B, air is introduced from the air introduction opening portion 56 provided near the upstream portion of the top plate 50a into the internal space of the shielding case 50 the periphery of which is substantially surrounded except for the discharge opening portion 53, and the air is an air flow 80B that flows so as to be emitted to the outside through the downstream gap S2 between the shielding case 50 and the peripheral surface of the photoconductor drum 11. Additionally, the air flow 80B flows so that a portion thereof passes through the discharge wire 52 and its periphery.

Incidentally, it is inferred that the reason why the air introduced from the air introduction opening portion 56 flows so as to be emitted to the outside through the downstream gap S2 between the shielding case 50 and the peripheral surface of the photoconductor drum 11 is based on the same reason as the case of the charging device 5A related to Exemplary Embodiment 1. Additionally, it is inferred that a reason why the air flow 80 flows so as to pass through the discharge wire 52 and its periphery is based on the same reason as the case of the charging device 5A related to Exemplary Embodiment 1.

In addition, the charging device 5A may be configured so that the air introduction opening portion 56 is provided in the other portion (for example, a downstream portion of the two equally divided portions in the upstream part 50M of the top plate 50a) equivalent to the upstream part 50M of the top plate 50a.

In contrast, in a case where the air introduction opening portion 56 is provided in a part (parts other than the upstream part 50M) located on the downstream side in the rotational direction A of the photoconductor drum 11 with reference to the corona discharge wire 52 of the shielding case 50 as a boundary, the results as follows are given. That is, although the air introduced into the inside of the shielding case 50 from the opening portion 56 flows under the influence of the aforementioned two types of air flows F1 and F2 (refer to FIG. 4) generated due to a potential difference between the corona discharge wire 52 and the peripheral surface of the photoconductor drum 11, the air mainly is an air flow that passes through a space portion located further toward the downstream side in the rotational direction of the photoconductor drum 11 than the discharge wire 52 inside the shielding case 50. Thus, the air flow in a space portion inside the shielding case 50 located further toward the upstream side in the rotational direction of the photoconductor drum 11 than the discharge wire 52 is hardly generated. Additionally, even in a case where the air flow is generated in the upstream space portion of the shielding case 50, the air flow does not become an air flow that emits the discharge products that are generated from the discharge wire 52 and are present in the upstream space portion, to the outside of the shielding case 50.

### Exemplary Embodiment 2

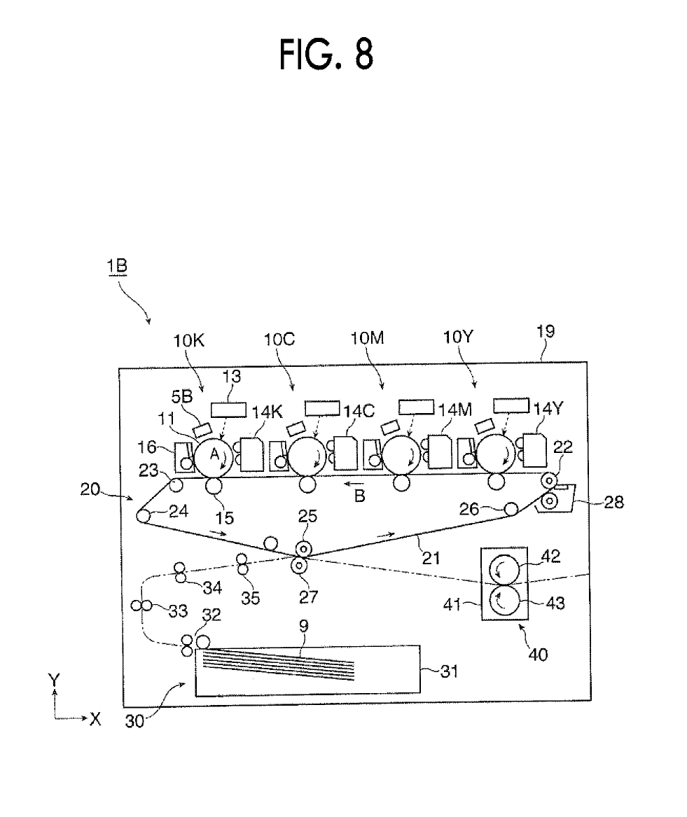

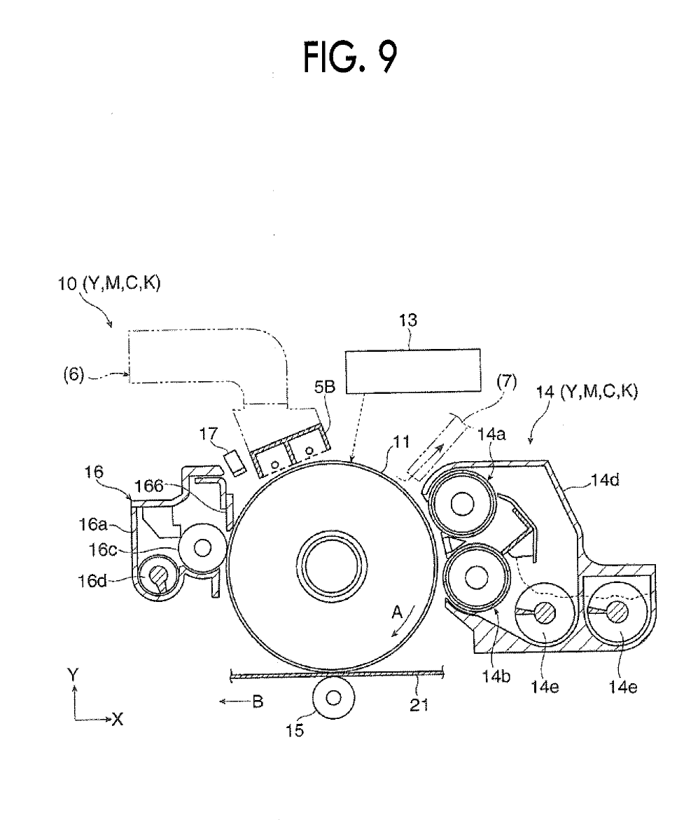

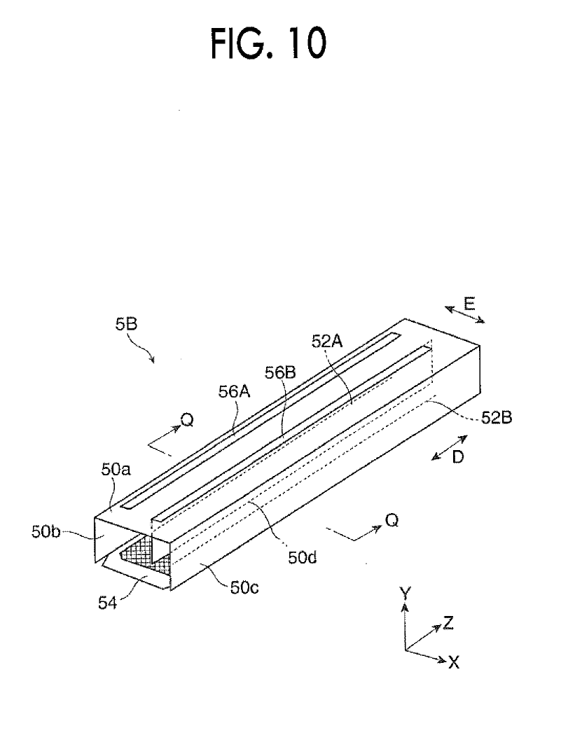

FIGS. 8 to 10 illustrate an image forming apparatus using a charging device as an example of the corona discharger related to Exemplary Embodiment 2. FIG. 8 illustrates the outline of the image forming apparatus, FIG. 9 illustrates an image forming device in the image forming apparatus, and FIG. 10 illustrates a portion of the charging device.

The image forming apparatus 1B is constituted of, for example, a color printer, uses plural image forming devices as the image forming devices 10, and has almost the same configuration as the image forming apparatus 1A related to Exemplary Embodiment 1 except for adding an intermediate transfer device 20 in relation to the plural image forming devices. That is, in the image forming apparatus 1E, as illustrated in FIG. 8, the plural image forming devices 10 (Y, M, C, and K), the intermediate transfer device 20 that holds toner images formed by the respective image forming devices 10, respectively, and finally secondarily transfers the toner images to the sheet 9 as an example of the recording material, the sheet feeder 30 that accommodates and transports a required sheet 9 to be supplied to a secondary transfer section of the intermediate transfer device 20, the fixing device 40 that causes the sheet 9, to which the toner images are transferred by the intermediate transfer device 20, to pass therethrough, and performs fixing of the toner images, and the like are arranged in the internal space of the housing 19.

The plural image forming devices 10 are constituted by four image forming devices 10Y, 10M, 10C, and 10K that exclusively form toner images in four colors of yellow (Y), magenta (M), cyan (C), and black (K), respectively. The four image forming devices 10 (Y, M, C, and K) are arranged so as to line up in series in the internal space of the housing 19.

Additionally, the respective image forming devices 10 (Y, M, C, and K) have a substantially common configuration as illustrated below except that the types of developers to be handled in the respective developing devices 14 are different. That is, the respective image forming devices 10 (Y, M, C, and K), as illustrated in FIG. 8 or FIG. 9, have photoconductor drums 11 that rotate in the direction illustrated by arrow A, respectively. A charging device 5B, the exposure device 13 that forms an electrostatic latent image (for each color), and the developing device 14 (Y, M, C, or K) that develops the electrostatic latent image with the toner of a developer in a corresponding color (Y, M, C, or K) to the electrostatic latent image, and forms a toner image, a primary transfer device 15 that transfers the toner image to the intermediate transfer device 20 (intermediate transfer belt 21), the drum cleaning device 16, and the charge remover 17 are mainly arranged around each photoconductor drum 11.

Among these, all the developing devices 14 (Y, M, C, and K) are of a type in which two developing rolls 14a and 14b are arranged in a container-like body 14d, and agitate a developer with two developer agitating and transporting members 14e to transport the developer toward the developing roll 14b. In the drum cleaning device 16, a cleaning plate (cleaning blade) 16b, a rotary brush roll 16c, a delivery member 16d, such as a screw auger which recovers unnecessary substances such as toner removed by the cleaning plate 16b and delivers the unnecessary substances to a recovery system (not illustrated), and the like are arranged in a container-like body 16a.

The charging device 5B, as illustrated in FIGS. 9 to 11 or the like, is constituted by the top plate 50a, the two long side lateral plates 50b and 50c, and a partition plate 50d that equally divides an internal section into two, and is constituted of a so-called scorotron type charging device including the shielding case 50 having the discharge opening portion 53 at the bottom thereof, the two end supports 51A and 51B (refer to FIG. 3), two corona discharge wires 52A and 52B, and the grid electrode (electric field adjustment plate) 54.

The charging device 5B is arranged such that the two corona discharge wires 52A and 52B face the peripheral surface (the surface to be charged) of the photoconductor drum 11 with a required gap (for example, a discharge gap), and are respectively present at least in an image forming target region along the direction C of the rotational axis of the photoconductor drum 11. Additionally, in the charging device 5B, charging voltages are respectively applied to the two discharge wires 52A and 52B (between the discharge wires and the photoconductor drum 11) from a power supply unit (not illustrated) if a required timing, such as image forming operation timing, comes. In Exemplary Embodiment 2, for example, alternating voltages are supplied as the charging voltages.

The intermediate transfer device 20, as illustrated in FIG. 8, is arranged so as to be present at positions below the respective image forming devices 10 (Y, M, C, and K). The intermediate transfer device 20 is mainly constituted of the intermediate transfer belt 21 that rotates in a direction illustrated by arrow B while passing through a primary transfer position between the photoconductor drum 11 and the primary transfer device 15 (primary transfer roll), plural support rolls 22 to 26 that hold and rotatably support the intermediate transfer belt 21 in a desired state from the inner surface thereof, a secondary transfer device 27 that rotates in contact with the outer peripheral surface (image holding surface) of the intermediate transfer belt 21 supported by the support roll 25 with a predetermined pressure, and a belt cleaning device 28 that removes and cleans unnecessary substances, such as toner and paper debris, which remain on and adhere to the outer peripheral surface of the intermediate transfer belt 21 after passing through the secondary transfer device 27. Among these, the support roll 22 is constituted as a driving roll, the support rolls 23 and 26 are constituted as driven rolls that hold the traveling position or the like of the belt, the support roll 24 is constituted as a tensioning roll, and the support roll 25 is constituted as a secondary transfer back-up roll.

Next, a basic image forming operation (printing) using the image forming apparatus 1B will be described. Here, a pattern of an image forming operation of forming a full color image configured by combining toner images in four colors (Y, M, C, and K), using all the four image forming devices 10 (Y, M, C, and K), will be representatively described.

In the image forming apparatus 13, if a start command for an image forming operation is received, in the four image forming devices 10 (Y, M, C, and K), the peripheral surfaces of the photoconductor drums 11 start to rotate and are charged with predetermined polarity and potential by the respective charging devices 5B. At this time, in the charging device 5B, corona discharge is generated in a state where charging voltages are applied to the two corona discharge wires 52A and 52B, respectively, and an electric field is formed between each of the discharge wires 52A and 52B and the peripheral surface of the photoconductor drum 11, and thereby, the peripheral surface of the photoconductor drum 11 is charged with a required potential. In this case, the charging potential of the photoconductor drum 11 is adjusted by the grid electrode 54.

Subsequently, electrostatic latent images of respective color components, which are configured with a required potential difference as exposure is performed on the basis of image information from the respective exposure devices 13, are formed on the peripheral surfaces of the respective charged photoconductor drums 11. Thereafter, when the electrostatic latent images of the respective color components formed on the photoconductor drums 11 pass through the developing devices 14, the electrostatic latent images are developed with toners in colors corresponding to the respective color components in a state where the images are charged with a required polarity supplied from the developing rolls 14a, and are visualized as toner images in four colors (Y, M, C, and K).

Next, the toner images in the respective colors formed on the respective photoconductor drums 11 are primarily transferred to the intermediate transfer belt 21, which rotates in the direction illustrated by arrow B in the intermediate transfer device 20, by the primary transfer devices 25 so as to overlap each other in order. The peripheral surfaces of the respective photoconductor drums 11 after the primary transfer are cleaned by the cleaning devices 16, and are then charge-removed by the charge remover 17. Subsequently, the intermediate transfer device 20 transports the toner images primarily transferred to the intermediate transfer belt 21 to a secondary transfer position, and then causes the secondary transfer device 27 to collectively secondarily transfer the toner images on the intermediate transfer belt 21 to the sheet 9 transported and fed from the sheet feeder 30. The peripheral surface of the intermediate transfer belt 21 after the secondary transfer is cleaned by the belt cleaning device 28.

Finally, the sheet 9 to which the toner images are secondarily transferred in the intermediate transfer device 20 is transported so as to be introduced into the fixing device 40 after being peeled off from the intermediate transfer belt 21 and, is then heated under pressurization when passing through the contact portion between the heating rotary member 42 and the pressurizing rotary member 43 in the fixing device 40, and then the toner images are melt and fixed on the sheet 9. The sheet 9 after this fixing is completed is ejected from the fixing device 40, and is transported and accommodated in an ejected sheet accommodation section (not illustrated) or the like that is formed, for example, outside the housing 19.

From the, a full color image configured by combining the toner images in four colors is formed on one surface of one sheet 9, and the basic image forming operation is completed. Additionally, when there is an instruction for the image forming operation for plural sheets, a series of operations as described above are similarly repeated by the number of sheets.

Detailed Configuration of Charging Device

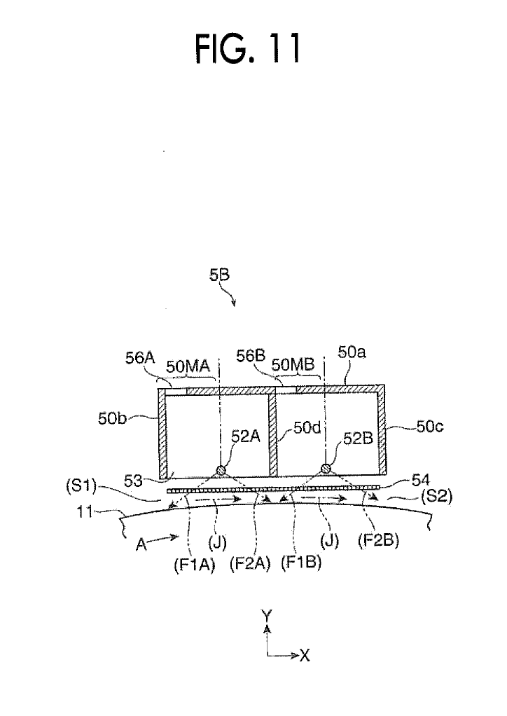

Additionally, in the charging device 5B related to Exemplary Embodiment 2, as illustrated in FIGS. 10 and 11 or the like, air introduction opening portions 56A and 56B that introduce air are respectively provided in portions (two regions partitioned by a partition plate 50d) of the top plate 50a that are examples of parts 50MA and 50B of the shielding case 50 located on the upstream sides in the rotational direction A of the photoconductor drum 11 with reference to the two corona discharge wires 52A and 52B as boundaries, respectively.

Both the two air introduction opening portions 56A and 56B are respectively formed as elongated holes along the longitudinal direction D, in the portions 50MA and 50MB that become upstream halves of the two regions of the top plate 50a divided by the partition plate 50d. The opening portion 56A is formed so as to be present at a position, close to the upstream lateral plate 50b, in one portion 50MA that is the upstream half. Additionally, the opening portion 56B is formed so as to be present at a position, close to the partition plate 50d, in the other portion 50MB that is the upstream half.

Additionally, as illustrated in FIG. 9, 12, or the like, a blowing device 6 for blowing air into the internal space of the shielding case 50 is provided together with the charging device 55.

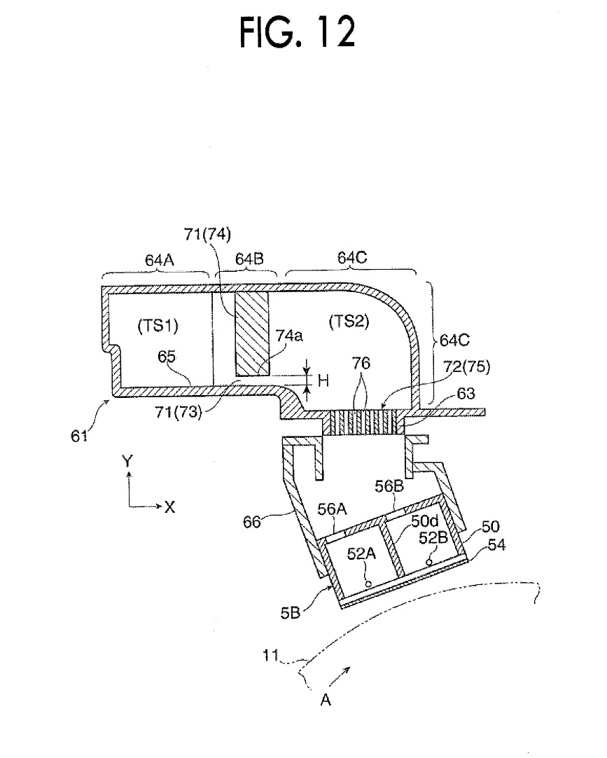

The blowing device 6, as illustrated in FIG. 12, 13, or the like, includes a blower 60 that has a rotary fan that sends air, and a blower duct 61 that takes in the air sent from the blower 60 and guides and emits the air to the charging device 5B that is an object against which air is blown. The blower duct 61 is formed in a shape having an inlet 62 that takes in the air sent from the blower t0, an outlet 63 that is arranged in a state where the outlet faces the portion (the top plate 50a of the shielding case 50), in the longitudinal direction D, of the elongated charging device 5B against which the air taken in from the inlet 62 is to be blown, and emits the air so as to flow along a direction orthogonal to the longitudinal direction D, and a passage portion 64 formed with a passage space TS for connecting the inlet 62 and the outlet 63 to cause air to flow therethrough.

The passage portion 64 of the blower duct 61 is constituted by an introduction passage portion 64A, a first bent passage portion 645, and a second bent passage portion 64C. The introduction passage portion 64A has the inlet 62 at one end portion and has a closed end portion at the other end portion, and the overall passage portion is constituted by an angular-tube-shaped passage portion formed so as to extend along the longitudinal direction C of the charging device 5B. The first bent passage portion 64B is an angular-tube-shaped passage portion formed so as to extend after being bent substantially at a right angle to a substantially horizontal direction (direction substantially parallel to the coordinate axis X) in a state where the width of the passage space is increased from a part near the other end portion of the introduction passage portion 64A. The second bent passage portion 64C is a passage portion formed so as to extend after being finally bent in a downwardly perpendicular direction (direction substantially parallel to the coordinate axis Y) so as to bring close to the charging device 5B in a state where the width of the passage space remains equal from one end portion of the first bent passage portion 64B. A termination end of the second bent passage portion 64C is formed with the outlet 63 including an opening shape that is slightly narrower than the cross-sectional shape of the passage space of the termination end (however, the longitudinal length of the oblong shape is almost the same). The widths (dimensions along the longitudinal direction 0) of both the passage spaces TS of the first bent passage portion 64B and the second bent passage portion 64C are set to almost the same dimension.

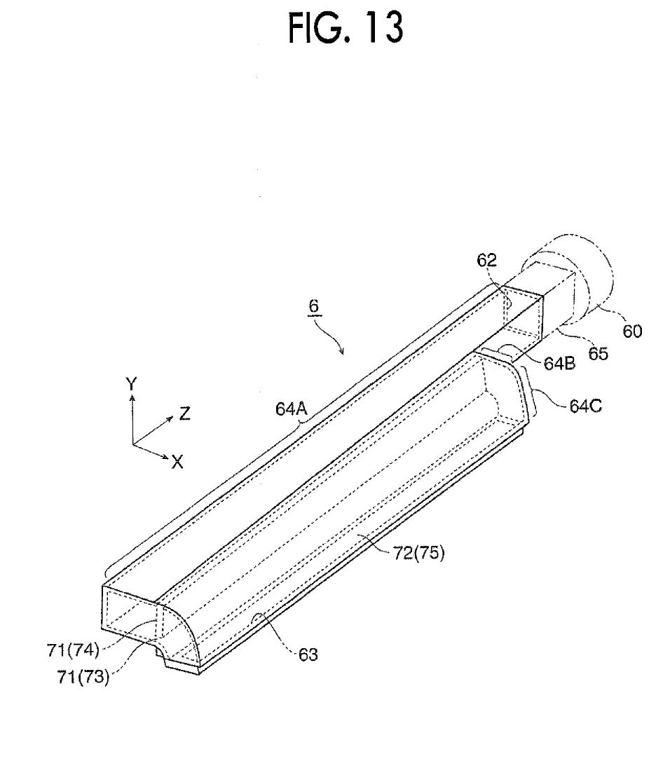

The inlet 62 of the blower duct 61 is formed so that the opening shape thereof is substantially square. A connection duct 65 for connecting between the blower duct and the blower 60 to send air from the blower 60 to the inlet 62 of the blower duct 61 is attached to the inlet 62 (FIG. 13). On the other hand, the outlet 63 of the blower duct 61 is formed so that the opening shape thereof is an elongated shape (for example, oblong shape) parallel to the portion of the charging device 5B in the longitudinal direction D. For this reason, the blower duct 61 has a relationship where the inlet 62 and the outlet 63 are formed in mutually different opening shapes. In addition, even the case where the inlet 62 and the outlet 63 have the same shape is included in the relationship where the inlet and the outlet are formed in mutually different opening shapes when the inlet and the outlet are formed so as to have mutually different opening areas (when the inlet and outlet have a similar shape).

Here, in the blower duct 61 in which the inlet 62 and the outlet 63 are formed in mutually different opening shapes in this way, the portion in which the cross-sectional shape of the passage space TS is changed on the way is present in the passage portion 64 that connects between the inlet 62 and outlet 63. Incidentally, in the blower duct 61, the cross-sectional shape of a passage space TS1 including a substantially square shape, of the introduction passage portion 64A is changed to the cross-sectional shape of a passage space TS2 including an oblong shape that widens only in the horizontal direction (irrespective of height) in the first bent passage portion 643. Also, in the case of the blower duct 61 in which such a portion in which the cross-sectional shape of the passage space TS changes is present, disturbance, such as flaking or vortex, occurs in the air flow in the portion in which the cross-sectional shape of the blower duct changes. For this reason, even if air with a uniform wind speed is taken in from the inlet 62, the wind speed of the air that comes out from the outlet 63 tends to become non-uniform.

In line with such a situation, as the blower duct 61 of the blowing device 6, as illustrated in FIG. 12, 13, or the like, two suppressing portions 71 and 72 that suppress the air flow are provided in different parts in the direction (the direction of the arrow represented by symbol N) that the air of the passage space TS of the passage portion 64 is caused to flow. The suppressing portion 72 of the two suppressing portions is an outlet suppressing portion (most downstream suppressing portion) provided at the outlet 63 that is a terminal of the passage portion 64, and the other suppressing portion 71 is an upstream suppressing portion provided in a part of the passage space TS of the passage portion 64 located further toward the most upstream side in the direction in which air is caused to flow than the outlet suppressing portion 62.

The upstream suppressing portion 71 is provided at a substantially intermediate position of the passage space TS of the first bent passage portion 64B in the direction in which air is caused to flow. The upstream suppressing portion 71 is configured so as to cut off a portion of the passage space TS2 in a state where the upstream suppressing portion runs along the direction parallel to the longitudinal direction (the same direction as the longitudinal direction D of the charging device 5B) of the opening shape of the outlet 63, and so as to have a gap 73 in a shape that extends in the longitudinal direction of the opening shape of the outlet 63. The upstream suppressing portion 71 in Exemplary Embodiment 2 is configured by causing a plate-shaped partition member 74 to be present within the passage space TS2 of the bent passage portion 643 without changing the external shape of the first bent passage portion 64B. Specifically, the partition member 74 closes an upper space portion in the passage space TS2 of the first bent passage portion 64B, and is arranged so that a lower end 74a of the partition member has a required gap (height) H with respect to a bottom (inner wall) 65 of the passage space TS2. This forms a structure where the gap 73 is present in a lower portion of the passage space TS2.

On the other hand, the outlet suppressing portion 72, as illustrated in FIG. 12 or the like, is formed by bringing about a state where the passage space (opening) in the termination end (outlet 63) of the second bent passage portion 64C is closed by a permeable member 75 having plural ventilation portions 76. All the plural ventilation portions 76 in the permeable member 75 are through holes that extend so that each opening shape is substantially circular and penetrates in the shape of a straight line. Additionally, the plural ventilation portions 76, for example, are arranged at a regular gaps along the longitudinal direction (D) of the opening shape of the outlet 63, and are arranged so as to be present in plural rows at the same gap as the regular gap even in the lateral direction F orthogonal to the longitudinal direction. Thereby, the plural ventilation holes 76 are formed so as to be dotted throughout the passage space of the terminating end of the second bent passage portion 64C, or the opening shape of the outlet 63. For this reason, the permeable member 75 is a perforated plate formed so that the plural ventilation portions (holes) 76 are dotted in a plate-shaped member.

As illustrated in FIG. 12 or the like, a connecting member 66 that connects the outlet 63 of the blower duct 61 of the blowing device 6 and the shielding case 50 (top plate 50a) in the charging device 5B is installed in the charging device 5B. It is possible to arrange, for example, a cleaning device or the like that cleans the discharge wires 52A and 52B of the charging device 5B in the internal space of the connecting member 66.

Blowing to the charging device 5B by the blowing device 6 is performed as follows.

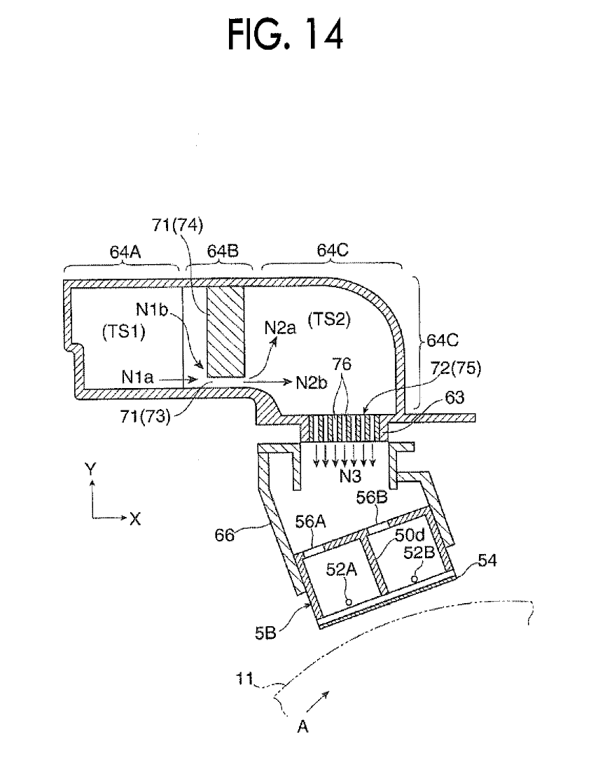

If the blowing device 6 arrives at blowing required timing, such as image forming operation timing, the blower 60 is first rotationally driven to send out a required volume of air. The air (N) sent out from the blower 60 is taken into the passage space TS of the passage portion 64 through the connection duct 65 from the inlet 62 of the blower duct 61. Subsequently, as illustrated in FIG. 14 or the like, the air (N) taken into the blower duct 61 is sent so as to flow into the passage space TS2 of the first bent passage portion 64B through the passage space TS1 of the introduction passage portion 64A (refer to arrows N1a, N1b, or the like of FIG. 14). The air (N1) sent into the first bent passage portion 64B passes through the gap 73 of the upstream suppressing portion 71, and proceeds in a state where the proceeding direction (direction in which air flows) thereof is changed to an almost right-angled direction.

In this case, the air (N1) when passing through the upstream suppressing portion 71 has its flow suppressed by the gap 63 of the first upstream suppressing portion 73 (the pressure of the air is raised), and tends to flow out of the gap 73 in a uniform state. Moreover, as for the air (N2) when flowing into the passage space TS2 of the first bent passage portion 64B after passing through the gap 73 of the suppressing portion 71, the direction of the air when flowing out of the gap 73 is aligned with a direction substantially orthogonal to the longitudinal direction (D) of the outlet 63.

Subsequently, the air (N2) that has flowed into the passage space TS2 of the second bent passage portion 64C flows into the passage space TS2 of the second bent passage portion 640 whose volume is larger than the passage space TS of the introduction passage portion 64A or the space of the gap 73, and is thereby swirled and stagnated within the passage space TS2 of the second bent passage portion 64C, and the unevenness of the wind speed is reduced. At this time, although a portion N2b of the air (N2) that has passed through the gap 73 of the upstream suppressing portion 71 and has flowed into the passage space 640 proceeds substantially linearly along the path of the gap 73, the other air E2a proceeds in such a curved manner that the air is diffused within the passage space TS of the second bent passage portion 64C, and flows so as to swirl within the passage space TS2.

Finally, the air (N2) that has flowed into and stagnated in the passage space TS2 of the second bent passage portion 640 passes through the plural ventilation portions (holes) 76 in the permeable member 75 that constitutes the outlet suppressing portion 72 provided at the outlet 63 that is a termination end of the bent passage portion 64C, and is thereby blown out from the outlet 63 in a state where the proceeding direction thereof is changed (refer to the arrow N3).

In this case, the air (N3) blown out from the outlet 63 passes through the plural ventilation portions 76 of the permeable member 75 that is relatively narrower than the opening area of the outlet 63, and is thereby sent out in a state where the flow thereof is suppressed (at this time, the pressure of the air is also raised). Additionally, the air (N3) that passes through the outlet suppressing portion 72 and is blown out from the outlet 63 passes through the plural ventilation portions 76 that are substantially uniformly dotted in the region of the outlet 63 and that are formed under the same conditions, and is thereby sent out from the outlet 63 in a uniform state. Moreover, the air (N3) blown out from the outlet 63 has its proceeding direction changed to the direction substantially orthogonal to the longitudinal direction D of the outlet 63 and the direction that faces the charging device 5B, and is sent out.

From the above, all of the air (N3) that passes the outlet suppressing portion 72 and comes out from the outlet 63 is sent out in a state where the proceeding direction thereof becomes the direction substantially orthogonal to the longitudinal direction of the outlet 63, and the wind speed thereof is brought into a substantially uniform state. Additionally, the wind speed of the air (N3) that comes out from the outlet 63 is brought into a substantially uniform state in the longitudinal direction (D) of the opening shape (oblong shape) of the outlet 63, and is brought into a substantially uniform state also in the lateral direction E. Then, the air (N3) sent out from the outlet 63 of the blower duct 61 in this blowing device 6, as illustrated in FIG. 14, flows in so as to be blown into the case 50 through the opening portions 56A and 56B in the top plate 50a of the shielding case 50 of the charging device 5B.

In the charging device 5B, when charge is performed, discharge products, such as ozone resulting from charges generated by corona discharge, are generated around the two corona discharge wires 52A and 52B, respectively, to which charging voltages are supplied.

Additionally, in the charging device 5B, the discharge products, as illustrated in FIG. 11, are influenced by air flows F1A, F2A, F1B, and F2B of air that are respectively directed to the peripheral surface of the photoconductor drum 11 from the discharge wires 52A and 52B generated due to respective potential differences (electric fields) between the two corona discharge wires 52A and 52B and respective peripheral surface portions of the photoconductor drum 11 and an air flow J generated between the peripheral surface of the photoconductor drum 11 and the charging device 5B by the rotation of the photoconductor drum 11, and are emitted to the outside, respectively, from the gaps S1 and S2 between the shielding case 50 and the peripheral surface of the photoconductor drum 11.

Here, the air flow F1A is a flow that flows toward the upstream side in the rotational direction A of the photoconductor drum 11 from the first discharge wire 52A with reference to the discharge wire 52A, and the air flow F2A is a flow that flows toward the downstream side in the rotational direction A of the photoconductor drum 11 from the discharge wire 52A with reference to the discharge wire 52A. Additionally, the air flow F2A is a flow that flows toward the upstream side in the rotational direction A of the photoconductor drum 11 from the second discharge wire 52B with reference to the discharge wire 52B, and the air flow F2B is a flow that flows toward the downstream side in the rotational direction A of the photoconductor drum 11 from the discharge wire 52B with reference to the discharge wire 52B.

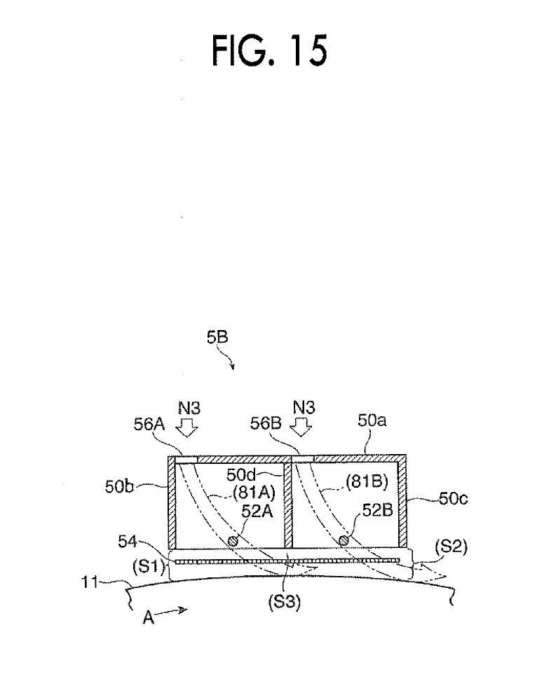

In contrast, in the charging device 5B, as illustrated by two-dot chain lines in FIG. 15, the air N3 blown from the blowing device 6 is forcedly introduced toward the top plate 50a of the shielding case 50 through the connecting member 66. The air N3 at this time is introduced into the internal spaces (two internal spaces partitioned by the partition plate 50d) of the shielding case 50 the peripheries of which are substantially surrounded except for the discharge opening portion 53 through the two air introduction opening portions 56A and 56B, respectively, provided in the parts 50MA and 50MB of the top plate 50a located on the respective upstream sides.

Thereby, the air introduced from the first air introduction opening portion 56A is an upstream air flow 81A that passes through a gap S3 between the partition plate 50d of the shielding case 50 and the peripheral surface of the photoconductor drum 11, and flows in the same direction as the rotational direction A along the peripheral surface of the photoconductor drum 11. Additionally, the air introduced from the second air introduction opening portion 56A becomes a downstream air flow 81B that flows so as to pass through the downstream gap S2 between the downstream lateral plate 50c of the shielding case 50 and the peripheral surface of the photoconductor drum 11 and so as to be emitted to the outside. Additionally, in this case, the upstream air flow 81A flows so as to join the downstream air flow 81B after passing through the gap S3, pass through the gap S2, and be emitted to outside. Moreover, the upstream air flow 81A flows so that a portion thereof passes through the first discharge wire 52A and a periphery thereof. The downstream air flow 81B flows so that a portion thereof passes through the second discharge wire 52B and a periphery thereof.

Incidentally, in the charging device 5B, the aforementioned air flows F1A and F2A that flow, respectively, toward the upstream sides in the rotational direction A of the photoconductor drum 11 from the respective discharge wires 52A and 52B generated due to potential differences between the respective discharge wires 52A and 52B and the peripheral surface of the photoconductor drum 11 are also generated in addition to the two air flows 81A and 81B. However, the wind forces of the air flows F1A and FIB become relatively smaller than the wind forces of the air flows 81A and 81B.

As a result, as the two air flows 81A and 81B are generated in the charging device 5B, discharge products generated around the respective discharge wires 52A and 52B, respectively, may be made to ride on the air flows 81A and 81B and may be emitted relatively much from the downstream gap S2 between the shielding case 50 and the peripheral surface of the photoconductor drum 11.

Performance Test

Next, a performance test regarding emission of discharge products (ozone) performed using the discharge device 5B will be described.

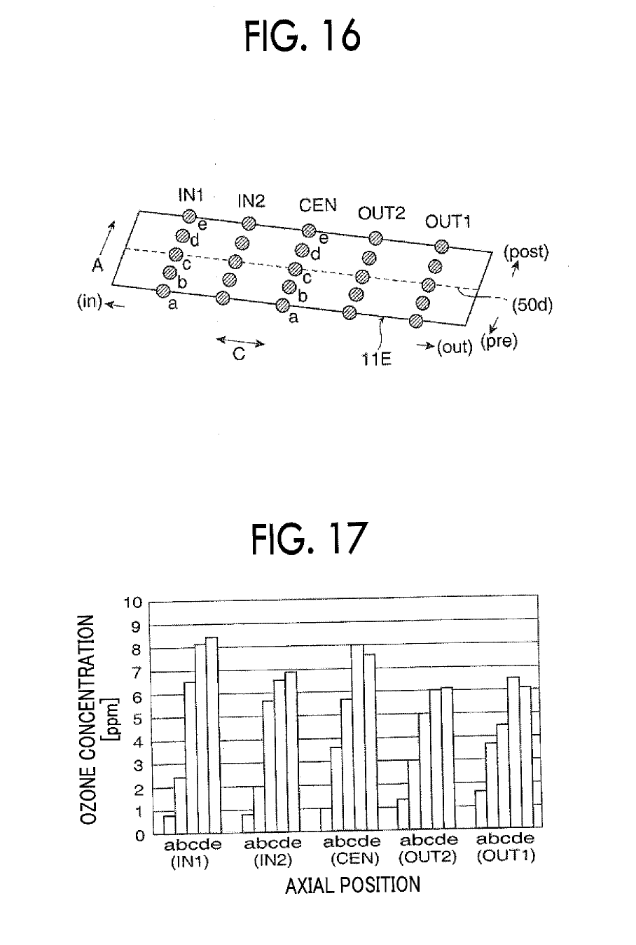

The test is performed by measuring ozone concentrations in plural points of a peripheral surface region 11E of the photoconductor drum 11 that faces the discharge opening portion 5B of the shielding case 50 of the charging device 5B when the photoconductor drum 11 is charged by the charging device 5B in one image forming device 10. The measurement of the ozone concentrations, as illustrated in FIG. 16, is performed using, as measurement positions, five points a to e equally divided along the rotational direction A of the photoconductor drum 11 in each of five axial positions (IN1, 1N2, CEN, OUT2, and OUT1) divided at equal intervals in the direction C of the rotational axis (from the IN side (deep side) of the image forming apparatus to the OUT side (near side) thereof), in the peripheral surface region 11E of the photoconductor drum 11.

The measurement of the ozone concentrations at this time is performed using a measuring machine made by Dylec Corp. (OZONE MONITOR MODEL 1200 (A-238)). The measurement at this time is made by installing plural ozone suction hoses which extend from the measuring machine at the respective measurement positions a to e distributed in the axial direction C, and performing suction under the following conditions. Suction hoses having an internal diameter of 2 mm are used, and air containing ozone is sucked under the condition of a wind speed of 7.96 m/second. Additionally, the charging by the charging device 5B is performed with a direct current voltage of −850 μA being supplied by a constant-current control method as the charging voltage and the peripheral surface of the photoconductor drum 11 that rotates at a velocity of 528 mm/second being charged with −750 V. Moreover, the air (N3) sent in from the blowing device 6 is set so that the air volume thereof is 0.25 m³/min.

FIG. 17 illustrates the results of the performance test regarding the charging device 5B. It may be seen from the results that ozone concentrations on the Post side (downstream end portion: particularly, the measurement positions of points a in the rotational direction A of the photoconductor drum 11) of the charging device 5B in all the axial positions have values higher than ozone concentrations on the Pre side (upstream end portion: particularly, the measurement positions of points e in the rotational direction A of the photoconductor drum 11), and thereby, the ozone generated by the charging operation of the charging device 5B is emitted relatively much on the Post side, in other words, the emission of ozone on the Pre side is suppressed. Additionally, as apparent from the below described comparison with the performance test results (FIG. 19) of Comparative Example 2, it may be seen that the total amount of the ozone concentrations measured also increases, and the ozone generated by the charging device 5B from this is rapidly emitted from the downstream gap (S2) between the shielding case 50 and the photoconductor drum 11 without stagnating within the internal space of the shielding case 50.

Comparative Example 2 and its Performance Test

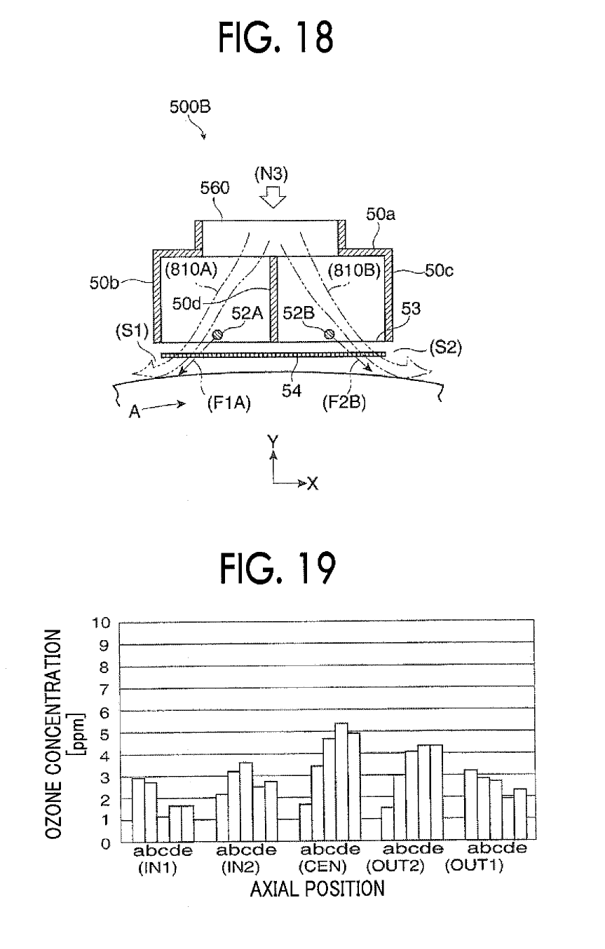

A charging device 500B as Comparative Example 2 illustrated in FIG. 18 merely for reference with respect to the charging device 5B is prepared, and the performance test regarding emission of discharge products (ozone) is also similarly performed on the charging device 500B.

In a case where the charging device 500B of Comparative Example 2 is contrasted with the charging device 5 related to Exemplary Embodiment 1, there is a difference in that one air introduction opening portion 560 is provided at a central portion (a portion that is present on both the upstream and downstream sides with the partition plate 50d as a center) of the top plate 50a of the shielding case 50. The opening portion 560 is formed as an oblong elongated hole along the longitudinal direction of the oblong top plate 50a. The dimensions of the internal space (including the discharge opening portion 53) of the shielding case 50 are the same as dimensions of the shielding case 50 of the charging device 5B. Additionally, in the charging device 500B, the air (N3) of the same conditions is sent into the internal space of the shielding case 50 through the air introduction opening portion 560 (via the connecting member 66) from the blowing device 6 provided together with the charging device 5B.

FIG. 19 illustrates the results of the performance test performed using the charging device 500B of Comparative Example 2. It may be seen from the results that ozone concentrations on the Pre side (upstream end portion in the rotational direction A of the photoconductor drum 11) of the charging device 500B have values higher than ozone concentrations on the Post side (downstream end portion in the rotational direction A of the photoconductor drum 11) depending on axial positions (for example, IN1 and OUT1), and thereby, ozone is emitted much also on the Pre side (upstream side) in the charging device 500B. Additionally, as apparent from the below described comparison with the performance test results (FIG. 17) of Exemplary Example 2, it is inferred that the total amount of the ozone concentrations measured decreases slightly, and the ozone generated by the charging device 500E from this stagnates within the internal space of the shielding case 50 (actually, moves so as to circulate within the internal space).

Also, in the charging device 500B of Comparative Example 2, as illustrated by two-dot chain lines in FIG. 18, the air (N3) is forcedly introduced from the air introduction opening portion 560 provided in the top plate 50a into the internal space of the shielding case 50, and the air is generated as an air flow 810 that is divided into two portions by the partition plate 50d and then finally flows so as to pass through both the upstream and downstream gaps S1 and S2 between the shielding case 50 and the peripheral surface of the photoconductor drum 11, and so as to be emitted to the outside. The air flow 810 is mainly divided into a portion 810A that flows so as to be emitted through the upstream gap S1, and a portion 810B that flows so as to be emitted through the downstream gap S2.

Incidentally, it is inferred that the divided air flow portions 810A and 810B are divided and flow as the air N3 forcedly introduced from the opening portion 560 is divided into two portions by the partition plate 50d and proceeds to sides where gaps are present in the peripheral surface of the photoconductor drum 11, respectively, but the divided air flow portions flow while being also influenced by the aforementioned upstream air flow F1A and downstream air flow F2B (refer to FIG. 18) that are generated clue to respective potential differences between the respective discharge wires 52A and 52B and the peripheral surface of the photoconductor drum 11. For this reason, the divided air flow portions 810A and 810E become air flows that flow with almost the same air volume. Additionally, both the air flow portions 810A and 810B flow so as to bypass the respective discharge wires 52A and 52B. This is inferred that high electric fields are formed in the vicinity of the discharge wires 52A and 52B, ion streams that always become outward (radial) flows of air of the respective wires are generated, and flows influenced by the ion streams are generated.

Modified Example of Charging Device

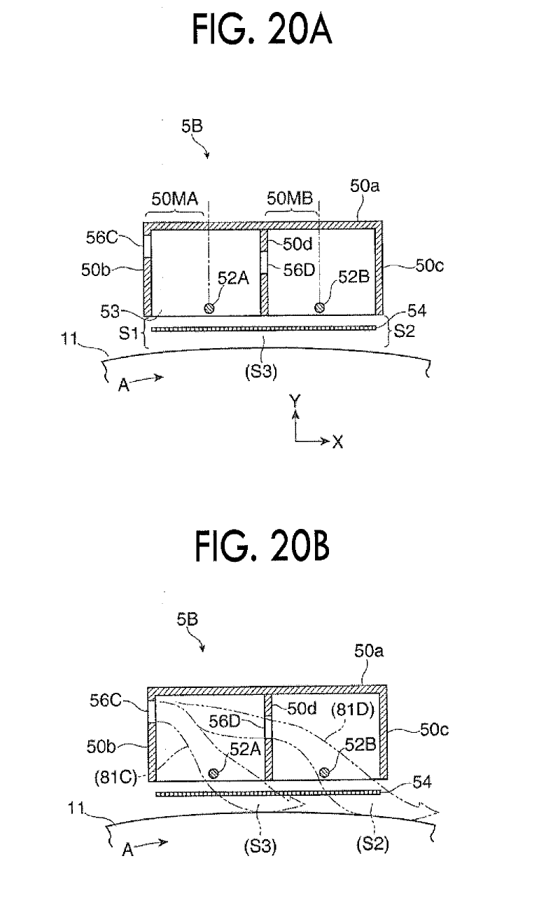

FIGS. 20A and 20B illustrate Modified Example 1 of the charging device 5B related to Exemplary Embodiment 2.

In the charging device 5B of this Modified Example 1, as illustrated in FIG. 20A, air introduction opening portions 56C and 56D are respectively provided in a portion of the upstream lateral plate 50b and a portion of the partition plate 50d that are examples of the parts 50MA and 50MB located on the upstream sides, respectively, in two regions of the shielding case 50 divided by the partition plate 50d. Both the air introduction opening portions 56C and 56D are formed as elongated holes along the longitudinal direction D of the lateral plate 50b and the partition plate 50d, substantially similarly to the opening portions 56A and 56B in Exemplary Embodiment 2. Additionally, the opening portion 56C provided in the lateral plate 50b is formed so as to be present at an upper end portion of the lateral plate 50c. The opening portion 56D provided in the partition plate 50d is formed so as to be present at a substantially central portion the partition plate 50d.

In the charging device 5B, as illustrated by two-dot chain lines in FIG. 20B, air is introduced into the internal spaces (two internal spaces partitioned by the partition plate 50d) of the shielding case 50 the peripheries of which are substantially surrounded except for the discharge opening portion 53 through the two air introduction opening portions 56C and 56D, respectively, provided in the parts 50MA and 50MB (the upstream lateral plate 50b and the partition plate 50d) of the top plate 50a located on the respective upstream sides.

Thereby, a portion of the air introduced from the first air introduction opening portion 56C becomes an upstream air flow 81C, a portion of which passes through the gap S3 between the partition plate 50d of the shielding case 50 and the peripheral surface of the photoconductor drum 11, and flows in the same direction as the rotational direction A along the peripheral surface of the photoconductor drum 11. Additionally, the other portion of the air introduced from the first air introduction opening portion 56C is introduced into the second air introduction opening portion 56D provided in the partition plate 50d. The air introduced into the second air introduction opening portion 56D becomes a downstream air flow 81D that flows so as to pass through the downstream gap S2 between the downstream lateral plate 50c of the shielding case 50 and the peripheral surface of the photoconductor drum 11 and so as to be emitted to the outside. In this case, the upstream air flow 810 flows so as to join the downstream air flow 81D after passing through the gap S3, pass through the gap S2, and be emitted to the outside. Also, the upstream air flow 81C flows so that a portion thereof passes through the first discharge wire 52A and the periphery thereof. The downstream air flow 81D flows so that a portion thereof passes through the second discharge wire 52B and the periphery thereof.

As a result, as the two air flows 81C and 81D are generated also in the charging device 5B of Modified Example 1, discharge products generated around the respective discharge wires 52A and 52B, respectively, may be made to ride on the air flows 81C and 81D and may be emitted relatively much from the downstream gap S2 between the shielding case 50 and the peripheral surface of the photoconductor drum 11.

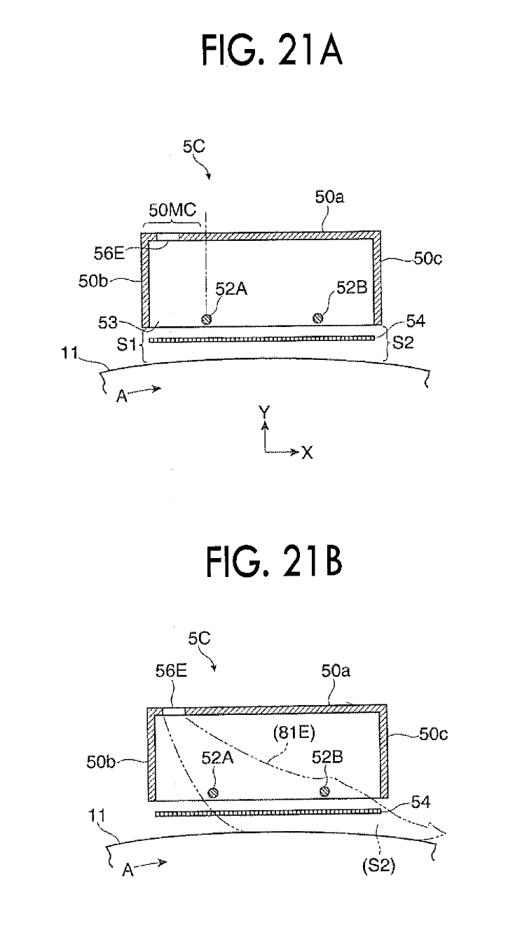

FIGS. 21A and 21B illustrate Modified Example 2 of the charging device 5B related to Exemplary Embodiment 2.

In a charging device 5C of this Modified Example 2, as illustrated in FIG. 21A, a shielding case having a structure in which the partition plate 50d is not installed is used as a shielding case 50. In the charging device 50, one air introduction opening portion 56E is provided in a portion 50MC of the top plate 50a that is an example of the part 50MC located on the upstream side in the rotational direction A with the discharge wire 52A located on the upstream side in the rotational direction A of the photoconductor drum 11 out of the two discharge wires 52A and 52B as a boundary. The air introduction opening portion 56E is formed as an elongated hole along the longitudinal direction D of the top plate 50a, substantially similarly to the opening portions 56A and 56B in Exemplary Embodiment 2.

In the charging device 5C, as illustrated by two-dot chain lines in FIG. 21B, air is introduced into the internal space of the shielding case 50 the periphery of which is substantially surrounded except for the discharge opening portion 53 through the air introduction opening portion 56E provided in the part 50MC (the upstream end region 50MC of the top plate 50a) located on the upstream side.

Thereby, the air introduced from the air introduction opening portion 56E becomes an air flow 81E that flows so as to pass through the downstream gap S2 between the downstream lateral plate 50c of the shielding case 50 and the peripheral surface of the photoconductor drum 11 and so as to be emitted to the outside, after flowing into the internal space of the shielding case 50 so as to spread and then passing through the respective discharge wires 52A and 52B. The air flow 81E flows so that a portion thereof passes through the first discharge wire 52A and the periphery thereof and the other portion thereof passes through the second discharge wire 52B and the periphery thereof.

As a result, as the air flow 81E is generated also in the charging device 50 of Modified Example 2, discharge products generated around the respective discharge wires 52A and 52B, respectively, may be made to ride on the air flow 81E and may be emitted relatively much from the downstream gap S2 between the shielding case 50 and the peripheral surface of the photoconductor drum 11. In addition, in the charging device 5C, the opening portion 56E may be provided so as to be present in (an upper end portion of) the upstream lateral plate 50b of the shielding case 50.

### Other Exemplary Embodiments

In the image forming apparatuses 1 (A, B) related to Exemplary Embodiment 1 and 2, it is desirable to provide the blowing device (6) together that forces air into each air introduction opening portion 56 in each charging device 5. However, in a case where such a blowing device is not provided together, for example, the following configurations may be adopted so as to effectively generate the air flow (air flow 80 or 81) introduced from each air introduction opening portion 56 in each charging device 5.

One configuration, as illustrated by two-dot chain lines in FIG. 9, is a configuration in which a suction and exhaust system (suction duct) 7 that sucks air (two-dot chain line with an arrow) and emits the air to the outside of the image forming apparatus 1 is installed within a region between the charging device 5(B) and the developing device 14 around the photoconductor drum 11. Additionally, with respect to an exhaust system that emits the air (heat or the like) within the housing 19 of the image forming apparatus 1 to the outside, an air flow path is designed so that the air within the housing 19 flows from the charging device 5 toward the developing device 14 in the image forming device 10.

In a case where plural air introduction opening portions 56 (A to D) are provided in the charging device 5B related to Exemplary Embodiment 2, it is preferable to configure the charging device so as to have a relationship in which the introduction amount or introduction flow velocity of air introduced from each opening portion 56 becomes relatively larger or faster as the opening portion is located further toward the upstream side in the rotational direction A of the photoconductor drum 11.

The reason why this configuration is preferable is as follows. That is, for example, the air flow F1A among the air flows F1A F2A, F1B, and F2B that are respectively directed to the peripheral surface of the photoconductor drum 11 from the discharge wires 52A and 52B generated due to respective potential differences (electric fields) between the two corona discharge wires 52A and 52B and respective peripheral surface portions of the photoconductor drum 11 becomes strong (or fast), and the proportion of discharge products that are emitted from the upstream gap S1 between the shielding case 50 and the peripheral surface of the photoconductor drum 11 increases. Thus, such phenomenon is effectively prevented by relatively increasing the intensity (speed) of an air flow. Additionally, the reason why the air flow F1A becomes strong (or fast) is because a peripheral surface portion of the drum 11 closer to the upstream side is less charged, and therefore, the potential difference between the peripheral surface portion and the upstream first discharge wire 52A becomes relatively the largest.

As a specific configuration for providing the relationship in which the introduction amount or introduction flow velocity of air introduced from each opening portion 56 becomes relatively larger or faster as the opening portion is located further toward the upstream side, for example, a configuration may be adopted in which the opening area of an opening portion 56 provided on the upstream side becomes relatively larger than the opening area of other opening portions 56 provided further toward the downstream side than the opening portion.

In addition, the corona discharger in which the shielding case 50 is provided with the air introduction opening portion 56 maybe a so-called corotron type corona discharger that does not include the grid electrode 54, without having to be limited to the scorotron type corona dischargers illustrated in Exemplary Embodiments 1 and 2. Additionally, the charging device 5 may include a cleaning device that cleans the corona discharge wires 52 or the grid electrode 54.

Additionally, the member to be charged, which is charged by the charging device 5, may be other members to be charged, without having to be limited to the photoconductor drum 11. Examples of the other members to be charged may include a belt-shaped photoconductor (photosensitive belt), a belt-shaped or drum-shaped intermediate transfer member or sheet transporting member, and the like. In a case where the member to be charged is the belt-shaped intermediate transfer member or sheet transporting member, discharge products generated from the charging device are accumulated on the rear surface side of the belt, and tend to cause image quality defects. For this reason, it is possible to appropriately provide the air introduction opening portion 56 in the shielding case of the charging device 5 to emit the discharge products in the direction in which the discharge products do not move to the rear surface side of the belt.

Moreover, the corona discharger in which the shielding case 50 is provided with the air introduction opening portion 56 may be configured as, for example, a charge removal unit that turns a high charging state into a low charging state, without having to be limited to the charging devices illustrated in Exemplary Embodiments 1 and 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A corona discharger comprising:
a discharge wire; and
a surrounding member, that is provided with an opening portion which is an entrance of an air flow, that faces a surface of a member to be charged that rotates around a rotational axis of the member to be charged, that is arranged with a gap from the surface to be charged, and that surrounds the discharge wire in the direction of the rotational axis,
wherein the opening portion is provided at a part of the surrounding member located on the upstream side of the discharge wire in a rotational direction of the member to be charged with the discharge wire.

2. The corona discharger according to claim 1,
wherein the surrounding member has a side wall located on the upstream side in the rotational direction of the member to be charged with the discharge wire, and
wherein the opening portion is provided in the side wall.

3. The corona discharger according to claim 1,
wherein the discharge wire includes a plurality of discharge wires arranged at an interval in the rotational direction of the member to be charged, and
wherein the opening portions are provided on an upstream side of a most upstream discharge wire in the plurality of discharge wires in the rotational direction of the member to be charged, and are respectively provided between adjacent discharged wires of the plurality of discharged wires.

4. The corona discharger according to claim 3,
wherein the respective opening portions of the surrounding member respectively provided in the respective upstream parts are configured to have a relationship in which the introduction amount or introduction flow velocity of air becomes relatively larger or faster in an opening portion located further toward the upstream side in the rotational direction of the member to be charged, and
wherein the opening area of one opening portion is larger than the opening area of the other opening portion provided on a downstream side of the one opening portion.

5. The corona discharger according to claim 3,
wherein partition plates for partitioning a discharge region are respectively arranged in the internal space of the surrounding member between adjacent discharge wires of the plurality of discharge wires, and
wherein the opening portions are also provided in the respective partition plates, respectively.

6. Teh corona discharger according to claim 4,
wherein partition plates for partitioning a discharge region are respectively arranged in the internal space of the surrounding member between adjacent discharge wires of the plurality of discharge wires, and
wherein the opening portions are also provided in the respective partition plates, respectively.

7. The corona discharger according to claim 1,
wherein the member to be charged has an endless belt-shaped.

8. The corona discharger according to claim 2,
wherein the member to be charged has an endless belt-shaped.

9. The corona discharger according to claim 3,
wherein the member to be charged has an endless belt-shaped.

10. The corona discharger according to claim 4,
wherein the member to be charged has an endless belt-shaped.

11. The corona discharger according to claim 5,
wherein the member to be charged has an endless belt-shaped.

12. The corona discharger according to claim 6,
wherein the member to be charged has an endless belt-shaped.

13. An image forming apparatus comprising:
the corona discharger according to claim 1.

14. An image forming apparatus comprising:
the corona discharger according to claim 3.
